(19) United States
(12) Patent Application Publication
(10) Pub. No.: US 2017/0069960 A1
(43) Pub. Date: Mar. 9, 2017

(54) ANTENNA

(71) Applicant: ASAHI GLASS COMPANY, LIMITED, Tokyo (JP)

(72) Inventors: Toshifumi FUNATSU, Tokyo (JP); Kazushi IWASAKI, Tokyo (JP)

(73) Assignee: ASAHI GLASS COMPANY, LIMITED, Tokyo (JP)

(21) Appl. No.: 15/254,470

(22) Filed: Sep. 1, 2016

(30) Foreign Application Priority Data
Sep. 4, 2015 (JP) 2015-174733
Jun. 23, 2016 (JP) 2016-124671
Aug. 9, 2016 (JP) 2016-156710

(51) Int. Cl. H01Q 1/32; H01Q 1/38

(52) U.S. Cl. CPC H01Q 1/3275; H01Q 1/38

(57) ABSTRACT

The present invention relates to an antenna including: a resin-made member to be attached to a vehicle body; an antenna element which is provided in the resin-made member and has a first length capable of resonating with a first frequency band; and a passive element which is provided in the resin-made member, capacitively coupled with the antenna element via a capacitive coupling portion, and has at least a region of a second length capable of resonating with a second frequency band which is different from the first frequency band by combining the second length with the first length of the antenna element.

### FIELD OF THE INVENTION

The present invention relates to an antenna.

### BACKGROUND OF THE INVENTION

In a vehicular antenna, there has been known a spoiler antenna in which a plurality of antennas such as an antenna for FM (Frequency Modulation) radio and an antenna for AM (Amplitude Modulation) radio are mounted in a rear spoiler (resin-made member) of a car (for example, see Patent Document 1).

In addition, in recent years, digital radio such as DAB (Digital Audio Broadcast) has been put into practice in addition to FM radio and AM radio. A DAB antenna has been generally provided individually as well as an antenna for FM radio and so on (for example, see Patent Document 2). DAB is constituted by two different frequency bands, that is, band III ranging from 174 MHz (megahertz) to 240 MHz, and L-band ranging from 1,452 MHz to 1,492 MHz.

Patent Document 1: Japanese Patent No. 4836737

Patent Document 2: JP-A-2014-216805

### SUMMARY OF THE INVENTION

For example, when reception of a frequency band of FM radio (hereinafter referred to as FM band) and reception of a frequency band of DAB (hereinafter referred to as DAB band) are implemented by a single antenna, the antenna must have a length of about (¾)λ (lambda: wavelength) of the FM band. However, according to a background-art antenna, an antenna having a length of about (¾)λ is difficult to be mounted in a limited space inside a rear spoiler (resin-made member).

The present invention provides an antenna in which an antenna capable of receiving a plurality of frequency bands can be miniaturized, and the antenna can be mounted in a limited space inside a resin-made member.

The present invention has the following aspects.

[1] An antenna including:

a resin-made member to be attached to a vehicle body:

an antenna element which is provided in the resin-made member and has a first length capable of resonating with a first frequency band; and

a passive element which is provided in the resin-made member, capacitively coupled with the antenna element via a capacitive coupling portion, and has at least a region of a second length capable of resonating with a second frequency band which is different from the first frequency band by combining the second length with the first length of the antenna element.

[2] The antenna according to [1], in which the antenna element and the passive element are arranged while putting a predetermined distance therebetween and being overlapped with each other by a third length, thereby being capacitively coupled with each other; and

the passive element has a length in which the third length is added to the second length.

[3] The antenna according to [1], in which the antenna element and the passive element are capacitively coupled with each other through a capacitor.

[4] The antenna according to [1], in which a first conductive plate which is a conductor is connected to one end of the antenna element,

a second conductive plate which is a conductor is connected to one end of the passive element, and

the first conductive plate and the second conductive plate are arranged to be opposed to each other while putting a predetermined distance therebetween.

[5] The antenna according to any one of [1] to [4], in which the second frequency band is higher than the first frequency band, and

the first length is one-quarter of a first wavelength within a first range corresponding to the first frequency band, and a total length of the first length and the second length is three-quarter of a second wavelength within a second range corresponding to the second frequency band.

[6] The antenna according to [5], in which the capacitive coupling portion has a capacitance value not to allow any signal in the first frequency band to pass therethrough.

[7] The antenna according to any one of [1] to [4], in which the first frequency band is higher than the second frequency band, and

the first length is one-quarter of a first wavelength within a first range corresponding to the first frequency band, and a total length of the first length and the second length is one-quarter or more of a second wavelength within a second range corresponding to the second frequency band.

[8] The antenna according to [7], in which the second length is one-half of a third wavelength within the first range.

[9] The antenna according to any one of [1] to [8], in which the antenna element and the passive element are arranged so as not to cross any interconnection arranged in the resin-made member.

[10] The antenna according to any one of [1] to [9], in which the resin-made member is a rear spoiler.

According to the present invention, an antenna capable of receiving a plurality of frequency bands can be miniaturized, and the antenna can be mounted in a limited space inside a resin-made member.

### BRIEF DESCRIPTION OF THE DRAWING

FIG. 1 is an external view showing an example of a spoiler antenna according to a first embodiment, which is mounted on a vehicle.

FIG. 2 is a diagram showing an internal configuration example of the spoiler antenna according to the first embodiment.

FIG. 3 is a diagram showing an equivalent circuit of an FM/DAB antenna according to the first embodiment.

FIG. 4 is a table showing antenna characteristics of the spoiler antenna according to the first embodiment.

FIG. 5 is a diagram showing an internal configuration example of a spoiler antenna according to a second embodiment.

FIG. 6 is a diagram showing an internal configuration example of a spoiler antenna according to a third embodiment.

FIG. 7 is a sectional view showing an example of a configuration of an FM/DAB antenna according to the third embodiment.

FIG. 8 is a diagram showing an equivalent circuit of an FM/DAB antenna according to a fourth embodiment.

FIG. 9 is a table showing antenna characteristics of a spoiler antenna according to the fourth embodiment.

FIG. 10 is a diagram showing an internal configuration example of a spoiler antenna according to a fifth embodiment.

FIG. 11 is a table showing antenna characteristics of the spoiler antenna according to the fifth embodiment.

FIG. 12 is a graph showing the relationship between an AM antenna length and an antenna characteristic in a DAB band.

FIG. 13 is a diagram showing a modification of the FM/DAB antenna according to the first embodiment.

### DETAILED DESCRIPTION OF THE INVENTION

The following definitions of terms will be applied to the whole of the present specification.

The term “FM band” means a frequency band of FM radio. The “FM band” is, for example, a frequency band ranging from 76 MHz (megahertz) to 108 MHz.

The term “DAB band” means a frequency band of DAB. The “DAB band” is, for example, a frequency band of band III ranging from 170 MHz to 240 MHz.

Antennas according to embodiments of the present invention will be described below with reference to the drawings.

### First Embodiment

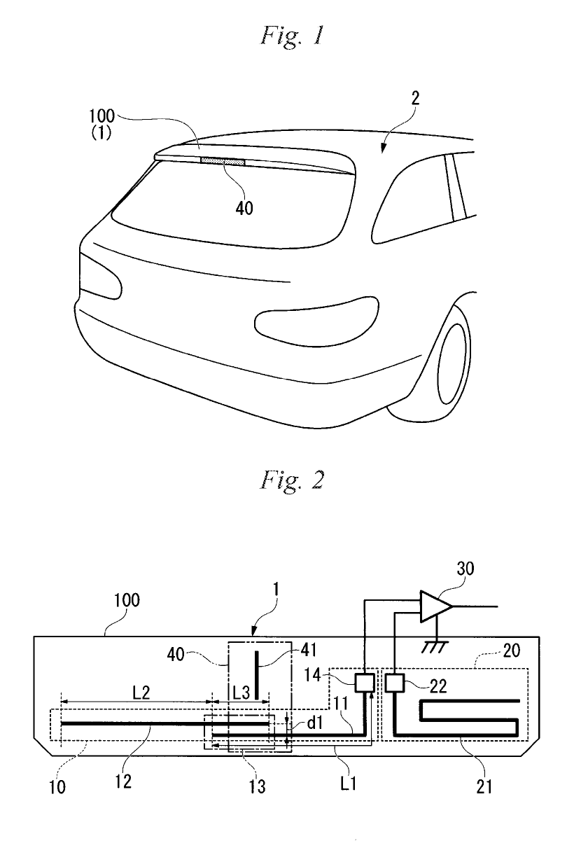

FIG. 1 is an external view showing an example in which a spoiler antenna 1 according to a first embodiment has been mounted on a vehicle. FIG. 2 is a diagram showing an internal configuration example of the spoiler antenna 1 according to the present embodiment.

A rear spoiler 100 (an example of a resin-made member) shown in FIG. 1 is attached to a rear portion of a vehicle body 2 of a car. In the present embodiment, the rear spoiler 100 corresponds to the spoiler antenna 1 (an example of an antenna) internally mounted with an FM/DAB antenna 10 and an AM antenna 20. In addition, the rear spoiler 100 has an HMSL (High Mount Stop Lamp) 40 above or under the FM/DAB antenna 10.

The spoiler antenna 1 shown in FIG. 2 includes the rear spoiler 100, the FM/DAB antenna 10, and the AM antenna 20. The FM/DAB antenna 10 is provided within a region enclosed by one of the broken lines. The AM antenna 20 is provided within a region enclosed by the other broken line. The upper side of FIG. 2 corresponds to the vehicle body 2 side.

The FM/DAB antenna 10 is an antenna that can receive radio waves both in an FM band and in a DAB band in spite of a single antenna. The FM/DAB antenna 10 has an antenna element 11, a passive element (parasitic element) 12, a capacitive coupling portion 13 in a region enclosed by the alternate long and short dash line, and a feeding point 14.

The antenna element 11 is made of a conducting wire, which is, for example, a metal wire covered with an insulator (dielectric) coating. The antenna element 11 is provided in the rear spoiler 100. For example, the antenna element 11 has a length L1 (first length) capable of resonating with an FM band (an example of a first frequency band). In addition, the length L1 is one-quarter of a wavelength (λ) at a central frequency of the FM band, that is, a length of (¼) wavelength (λ). Power is fed to the antenna element 11 through the feeding point 14.

Incidentally, the “length of (¼) wavelength (λ)” will be sometimes referred to as “(¼)λ resonance length” in the following description. On the other hand, the “wavelength at the central frequency of the FM band” will be sometimes referred to as “λ_{FM}.”.

In addition, the length L1 may be one-quarter of a wavelength (first wavelength) within a predetermined wavelength range (first range) corresponding to the FM band. Here, the predetermined wavelength range is a range from a wavelength obtained by multiplying a wavelength λ_{FMmin} corresponding to the highest frequency of the FM band by a predetermined coefficient to a wavelength obtained by multiplying a wavelength λ_{FMmax} corresponding to the lowest frequency of the FM band by a predetermined coefficient. For example, the predetermined wavelength range is expressed by (1−k)×λ_{FMmin}≦λ_{FM}≦(1+k)×λ_{FMmax}. When k=0.21, 0.79×λ_{FMmin}≦λ_{FM}≦1.21×λ_{FMmax}. That is, the length L1 may be (0.79×λ_{FMmin}/4) or more and (1.21×λ_{FMmax}/4) or less.

The passive element 12 is made of a conducting wire, which is a metal wire covered with an insulator coating, in the same manner as the antenna element 11. The passive element 12 is provided in the rear spoiler 100. For example, in the capacitive coupling portion 13, the passive element 12 is capacitively coupled with the antenna element 11 by a predetermined capacitance value. In addition, the capacitive coupling portion 13 has, for example, a capacitance value not to allow any signal in the FM band to pass from the antenna element 11 to the passive element 12. That is, the capacitive coupling portion 13 has a function as a high pass filter for prohibiting any signal in the FM band from passing therethrough. In addition, the passive element 12 has at least a region of a length L2 (second length) capable of resonating with a DAB band (an example of a second frequency band) which is different from the FM band by combining the length L2 with the length L1 of the antenna element 11. In addition, the DAB band is a frequency hand higher than the FM band. In addition, the total length of the length L1 and the length L2 is, for example, three-quarter of a wavelength (λ) at a central frequency of the DAB band, that is, a length of (¾) wavelength (λ).

Incidentally, the “length of (¾) wavelength (λ)” will be sometimes referred to as “(¾)λ resonance length” in the following description. On the other hand, the “wavelength at the central frequency of the DAB band” will be sometimes referred to as “λ_{DAB}”.

In addition, the total length of the length L1 and the length L2 may be three-quarter of a wavelength (second wavelength) within a predetermined wavelength range (second range) corresponding to the DAB band. Here, the predetermined wavelength range is a range from a wavelength obtained by multiplying a wavelength λ_{DABmin} corresponding to the highest frequency of the DAB band by a predetermined coefficient to a wavelength obtained by multiplying a wavelength λ_{DABmax} corresponding to the lowest frequency of the DAB band by a predetermined coefficient. For example, the predetermined wavelength range is expressed by (1−k)×λ_{DABmin}≦λ_{DAB}≦(1+k)×λ_{DABmax}. When k=0.21, 0.79×λ_{DABmin}≦λ_{DAB}≦1.21×λ_{DABmax}. That is, the total length of the length L1 and the length L2 may be (0.79×λ_{DABmin}×¾) or more and (1.21×λ_{DABmax}×¾) or less.

In addition, the antenna element 11 and the passive element 12 are arranged while putting a distance d1 (predetermined distance) therebetween and being overlapped with each other by a length L3 (predetermined length) so that the antenna element 11 and the passive element 12 can be capacitively coupled with each other by a predetermined capacitance value. That is, the antenna element 11 and the passive element 12 are arranged so that their conducting wires (interconnections) can overlap with each other by the length L3 and the distance d1. The length L3 and the distance d1 are set so as to obtain a capacitance value not to allow any signal in the FM band to pass from the antenna element 11 to the passive element 12. The distance d1 is, for example, a value not larger than 30 mm (millimeters).

In addition, the antenna element 11 and the passive element 12 are arranged so as not to cross any other interconnection (for example, a stop lamp wiring 41) arranged in the rear spoiler 100. For example, it is preferable that the antenna element 11 and the passive element 12 are arranged to be as distant from any other metal part such as the vehicle body 2 as possible. That is, it is preferable that, among the antenna element 11 and the passive element 12, a part of the element including the capacitive coupling portion 13 are arranged on the opposite side to the vehicle body 2 in the rear spoiler 100.

The capacitive coupling portion 13 is a part with the length L3 and the distance d1 in which the antenna element 11 and the passive element 12 are arranged to overlap with each other. In addition, the length of the passive element 12 is the total length of the length L2 and the length L3 shown in FIG. 2.

The feeding point 14 is connected to one end of the antenna element 11. Power is fed to the antenna element 11 through the feeding point 14. A signal corresponding to a radio wave received by the FM/DAB antenna 10 is supplied from the feeding point 14 to an amplifier 30 provided in the vehicle body 2.

The AM antenna 20 is an antenna that can receive radio waves for AM radio. The AM antenna 20 has an antenna element 21 and a feeding point 22.

The antenna element 21 is made of a conducting wire, which is a metal wire covered with an insulator coating.

The feeding point 22 is connected to one end of the antenna element 21. Power is fed to the antenna element 21 through the feeding point 22. A signal corresponding to a radio wave received by the AM antenna 20 is supplied from the feeding point 22 to the amplifier 30.

The amplifier 30 amplifies the signal received by the FM/DAB antenna 10 and the signal received by the AM antenna 20, and supplies the amplified signals to devices such as a car radio receiver, and a car audio device mounted on the car.

A high mount stop lamp (HMSL) 40 is a stop lamp attached to the rear spoiler 100. In addition, the stop lamp wiring 41 is a wiring for supplying electric power to the HMSL 40. The stop lamp wiring 41 is arranged inside the rear spoiler 100. In addition, in FIG. 2, assume that the HMSL 40 is arranged in a position enclosed by the alternate long and two short dashes lines.

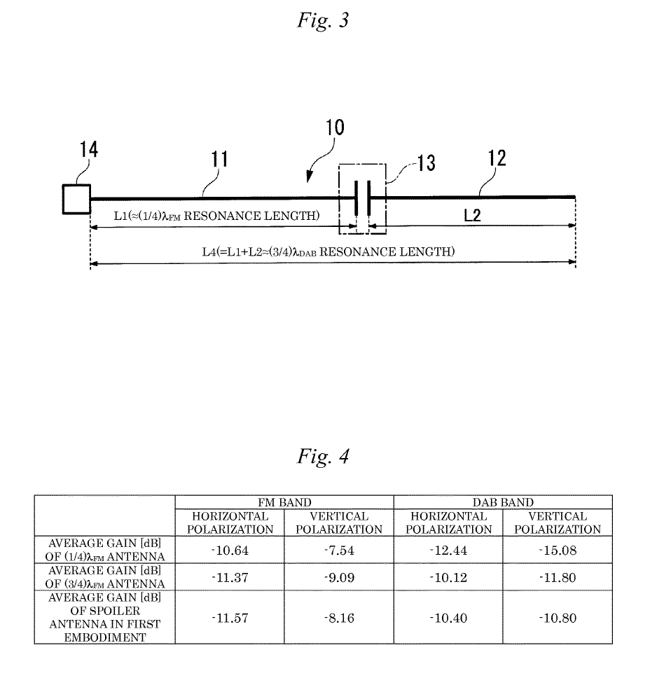

Next, an equivalent circuit of the FM/DAB antenna 10 according to the present embodiment will be described with reference to FIG. 3.

FIG. 3 is a diagram showing an equivalent circuit of the FM/DAB antenna 10 according to the present embodiment.

As shown in FIG. 3, the FM/DAB antenna 10 can be expressed as an equivalent circuit in which the capacitive coupling portion 13 has been replaced by a capacitor.

The antenna element 11 is an antenna having the length L1 almost as long as the (¼)λ_{FM} resonance length (i.e., L1≈(¼)λ_{FM} resonance length). The antenna element 11 can receive radio waves in the FM band efficiently. That is, when the FM/DAB antenna 10 receives radio waves in the FM band, the antenna element 11 serves as a (¼) wavelength antenna for the FM band.

On the other hand, the passive element 12 is connected to the antenna element 11 through a capacitor. A total length L4 of the length L2 of the passive element 12 and the length L1 of the antenna element 11 is almost as long as the (¾)λ_{DAB} resonance length (i.e., L4=L1+L2≈(¾)λ_{DAB} resonance length), thereby being able to receive radio waves in the DAB band efficiently. That is, when the FM/DAB antenna 10 receives radio waves in the DAB band, the antenna element 11 and the passive element 12 serve as a (¾) wavelength antenna for the DAB band. The length L4 of the FM/DAB antenna 10 is, for example, a length of about 1 m.

In this manner, the FM/DAB antenna 10 according to the present embodiment can receive radio waves in the FM band efficiently using the antenna element 11 almost as long as the (¼)λ_{FM} resonance length, and receive radio waves in the DAB band efficiently using the antenna element 11 and the passive element 12 almost as long as the (¾)λ_{DAB} resonance length. That is, by adding the passive element 12 to the pointed end of the antenna element 11, the FM/DAB antenna 10 can receive both the radio waves in the FM band and the radio waves in the DAB band efficiently.

Next, the antenna characteristics of the FM/DAB antenna 10 according to the present embodiment will be described with reference to FIG. 4.

FIG. 4 is a table showing the antenna characteristics of the spoiler antenna 1 according to the present embodiment. FIG. 4 shows measurement results of antenna characteristics among a background-art antenna for the FM band, a background-art antenna for the FM band and the DAB band, and the spoiler antenna 1 according to the present embodiment.

The background-art antenna for the FM band used in the measurement shown in FIG. 4 does not have any passive element but is made of a single conducting wire, which is a metal wire covered with an insulator coating. In addition, the background-art antenna for the FM band has a length (0.6 m) that is one-quarter of a wavelength at a frequency in the FM band. In the description of FIG. 4, the background-art antenna for the FM band will be referred to as “(¼)λ_{FM} antenna”.

On the other hand, the background-art antenna for the FM band and the DAB band used in the measurement shown in FIG. 4 does not have any passive element but is made of a single conducting wire, which is a metal wire covered with an insulator coating. In addition, the background-art antenna for the FM band and the DAB band has a length (2.2 m) that is three-quarter of the wavelength at the frequency in the FM band. In the description of FIG. 4, the background-art antenna for the FM band and the DAB band will be referred to as “(¾)λ_{FM} antenna”.

In FIG. 4, items on the vertical axis show “average gain [dB (decibel)] of (¼)λ_{FM} antenna”, “average gain [dB] of (¾)λ_{FM} antenna”, and “average gain [dB] of spoiler antenna according to first embodiment” respectively in the order from top to bottom.

The “average gain [dB (decibel)] of (¼)λ_{FM} antenna” shows the characteristics of the background-art antenna for the FM band. In addition, the “average gain [dB] of (¾)λ_{FM} antenna” shows the characteristics of the background-art antenna for the FM band and the DAB band. The background-art antenna for the FM band and the DAB band must be about 2.2 m long. In addition, the “average gain [dB] of spoiler antenna according to first embodiment” shows the characteristics of the FM/DAB antenna 10.

On the other hand, items on the horizontal axis show “horizontal polarization” and “vertical polarization” in the “FM band”, and “horizontal polarization” and “vertical polarization” in the “DAB band”, respectively.

As shown in FIG. 4, the “average gain [dB] of (¼)λ_{FM} antenna” is “−12.44” in “horizontal polarization” and “−15.08” in “vertical polarization” for the “DAB band”. On the other hand, the “average gain [dB] of spoiler antenna according to first embodiment” is “−10.40” in “horizontal polarization” and “−10.80” in “vertical polarization” for the “DAB band”. As a result, the measurement results shown in FIG. 4 show that the reception characteristics for the “DAB band” in the FM/DAB antenna 10 according to the present embodiment are improved by 2 dB to 4 dB as compared with the background-art antenna for the FM band.

Further, as shown in FIG. 4, the “average gain [dB] of (¾)λ_{FM} antenna” is “−11.37” in “horizontal polarization” and “−9.09” in “vertical polarization” for the “FM band”. In addition, the “average gain [dB] of (¾)λ_{FM} antenna” is “−10.12” in “horizontal polarization” and “−11.80” in “vertical polarization” for the “DAB band”.

On the other hand, the “average gain [dB] of spoiler antenna according to first embodiment” is “−11.57” in “horizontal polarization” and “−8.16” in “vertical polarization” for the “FM band”. In addition, the “average gain [dB] of spoiler antenna according to first embodiment” is “−10.40” in “horizontal polarization” and “−10.80” in “vertical polarization” for the “DAB band”.

As a result, the measurement results shown in FIG. 4 show that the FM/DAB antenna 10 according to the present embodiment has equivalent reception characteristics for both the “FM band” and the “DAB band” to those in the background-art antenna for the FM band and the DAB band. In addition, the FM/DAB antenna 10 according to the present embodiment is about 1 m long. The FM/DAB antenna 10 according to the present embodiment can attain miniaturization as compared with the background-art antenna for the FM band and the DAB band, which must be about 2.2 m long.

As described above, the spoiler antenna 1 according to the present embodiment includes the rear spoiler 100 (resin-made member) to be attached to the vehicle body 2, the antenna element 11, and the passive element 12. The antenna element 11 is provided in the rear spoiler 100, and has the length L1 (first length) capable of resonating with a first frequency band (for example, the FM band). The passive element 12 is provided in the rear spoiler 100, and capacitively coupled with the antenna element 11 by a predetermined capacitance value. That is, the passive element 12 is capacitively coupled with the antenna element 11 via a capacitive coupling portion 13. The passive element 12 has at least a region of the length L2 (second length) capable of resonating with a second frequency band (for example, the DAB band) which is different from the first frequency band (for example, the FM band) by combining the length L2 with the length L1 of the antenna element 11.

In this manner, in the spoiler antenna 1 according to the present embodiment, the antenna element 11 serves as an antenna for reception in the first frequency band (for example, the FM band), and the antenna element 11 and the passive element 12 cooperate to serve as an antenna for reception in the second frequency band (for example, the DAB band). As a result, the spoiler antenna 1 according to the present embodiment can receive both the first frequency band (for example, the FM band) and the second frequency band (for example, the DAB band) and can miniaturize the antenna (FM/DAB antenna 10), as shown in FIG. 4. Thus, according to the spoiler antenna 1 according to the present embodiment, an antenna capable of receiving in a plurality of frequency bands can be miniaturized, and the antenna can be mounted in a limited space within the rear spoiler 100 (resin-made member).

In addition, according to the present embodiment, the antenna element 11 and the passive element 12 are arranged to overlap with each other at a predetermined distance (for example, the distance d1) and over a predetermined length (for example, the length L3) so as to reach a predetermined capacitance value therebetween. That is, the antenna element 11 and the passive element 12 are extended in parallel to be capacitively coupled with each other. That is, the antenna element 11 and the passive element 12 are arranged while putting a predetermined distance (for example, the distance d1) therebetween and being overlapped with each other, for example, by the length L3 (third length) so as to reach a predetermined capacitance value, thereby being capacitively coupled with each other. The passive element 12 has a length in which a predetermined length (for example, the length L3 (third length)) is added to the length L2.

In this manner, according to the spoiler antenna 1 according to the present embodiment, reception in a plurality of frequency bands (for example, both the FM band and the DAB band) can be achieved by a simple manner in which the antenna element 11 and the passive element 12 are arranged to overlap with each other.

In addition, according to the present embodiment, the second frequency band (for example, the DAB band) is higher than the first frequency band (for example, the FM band). The length L1 is a length corresponding to a (¼) wavelength at a frequency belonging to the first frequency band (for example, the FM band), and the total length of the length L1 and the length L2 is a length corresponding to a (¾) wavelength at a frequency belonging to the second frequency band (for example, the DAB band). For example, the length L1 is one-quarter of a first wavelength within a first range corresponding to the first frequency band, and the total length of the length L1 and the length L2 is three-quarter of a second wavelength within a second range corresponding to the second frequency band. Specifically, the length L1 is, for example, (0.79×λ_{FMmin}/4) or more and (1.21×λ_{FMmax}/4) or less, and the total length of the length L1 and the length L2 is, for example, (0.79×λ_{DABmin}×¾) or more and (1.21×λ_{DABmax}×¾) or less.

In this manner, according to the spoiler antenna 1 according to the present embodiment, reception both in the first frequency band (for example, the FM band) and in the second frequency band (for example, the DAB band) can be attained, while the antenna (FM/DAB antenna 10) can be miniaturized to be as long as about the (¾) wavelength of the second frequency band (for example, the DAB band).

In addition, according to the present embodiment, the predetermined capacitance value is determined not to allow any signal in the first frequency band (for example, the FM band) to pass therethrough.

Thus, according to the spoiler antenna 1 according to the present embodiment, the influence of the passive element 12 is reduced during reception in the first frequency band (for example, the FM band), so that efficient reception in the first frequency band (for example, the FM band) can be attained. On the other hand, according to the spoiler antenna 1 according to the present embodiment, the passive element 12 is effectuated during reception in the second frequency band (for example, the DAB band), so that efficient reception in the second frequency band (for example, the DAB band) can be attained.

### Second Embodiment

Next, a spoiler antenna 1a according to a second embodiment will be described with reference to the drawings.

FIG. 5 is a diagram showing an internal configuration example of the spoiler antenna 1a according to the second embodiment. Incidentally, the external appearance of the spoiler antenna 1a is similar to that in the first embodiment shown in FIG. 1. Therefore, description about the external appearance of the spoiler antenna 1a will be omitted.

The spoiler antenna 1a according to the present embodiment is an example in which a capacitor 13a is provided in place of the capacitive coupling portion 13 in the first embodiment.

The spoiler antenna 1a shown in FIG. 5 includes a rear spoiler 100, an FM/DAB antenna 10a, and an AM antenna 20. Incidentally, in FIG. 5, constituents the same as those in FIG. 1 are referenced correspondingly, and description thereof will be omitted.

The FM/DAB antenna 10a is an antenna that can receive radio waves both in an FM band and in a DAB band in spite of a single antenna. The FM/DAB antenna 10a includes an antenna element 11, a passive element (parasitic element) 12a, a capacitor 13a, and a feeding point 14.

The passive element 12a is made of a conducting wire, which is a metal wire covered with an insulator coating, in the same manner as the antenna element 11. The passive element 12a is provided in the rear spoiler 100. For example, the passive element 12a is capacitively coupled with the antenna element 11 through the capacitor 13a by a predetermined capacitance value. In addition, the passive element 12a also has a region of a length L2 (second length) capable of resonating with a DAB band (an example of a second frequency band) which is different from the FM band by combining the length L2 with the length L1 of the antenna element 11. Differently from the passive element 12 in the first embodiment, the passive element 12a in the second embodiment does not have a conducting wire part having a length L3 corresponding to the capacitive coupling portion 13.

The capacitor 13a is connected between the passive element 12a and one end of the antenna element 11 on the side where the antenna element 11 is not connected to the feeding point 14. Due to the capacitor 13a, the antenna element 11 and the passive element 12a are capacitively coupled with each other by a predetermined capacitance value. In addition, the predetermined capacitance value is determined not to allow any signal in the FM band to pass from the antenna element 11 to the passive element 12a, in the same manner as in the first embodiment. In the present embodiment, the capacitor 13a serves as the capacitive coupling portion 13.

An equivalent circuit of the FM/DAB antenna 10a in the present embodiment is similar to that in the first embodiment shown in FIG. 3, and description thereof will be omitted. In addition, the operation of the FM/DAB antenna 10a in the present embodiment is fundamentally similar to that of the FM/DAB antenna 10 in the first embodiment, except that the antenna element 11 and the passive element 12a are capacitively coupled with each other by the capacitor 13a in place of the capacitive coupling portion 13.

As described above, according to the spoiler antenna 1a according to the present embodiment, the antenna element 11 and the passive element 12a are capacitively coupled with each other through the capacitor 13a having a predetermined capacitance value.

Thus, according to the spoiler antenna 1a according to the present embodiment, an antenna capable of receiving in a plurality of frequency bands can be miniaturized, and the antenna can be mounted in a limited space within the rear spoiler 100, in the same manner as in the first embodiment.

In addition, in the spoiler antenna 1a according to the present embodiment, the antenna element 11 and the passive element 12a are capacitively coupled with each other through the capacitor 13a. Thus, stable capacitive coupling can be attained.

### Third Embodiment

Next, a spoiler antenna 1b according to a third embodiment will be described with reference to the drawings.

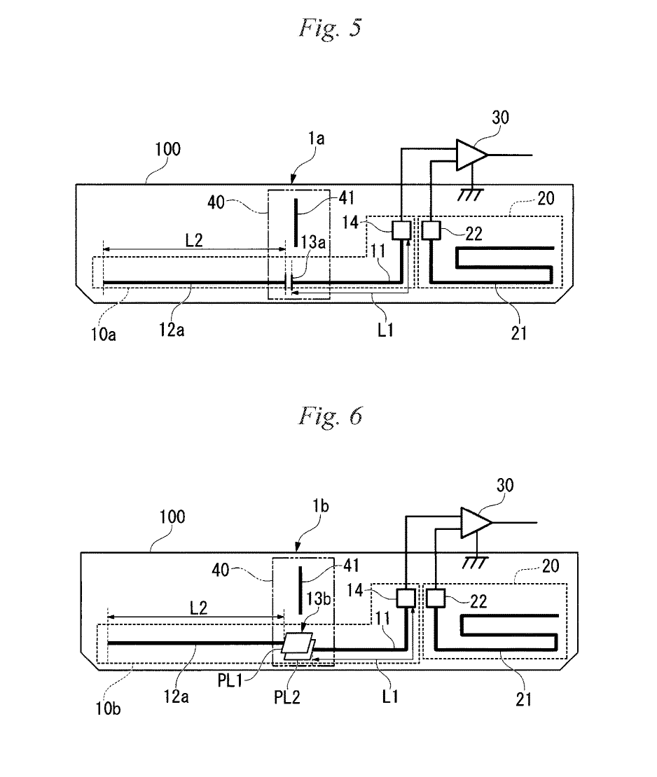

FIG. 6 is a diagram showing an internal configuration example of the spoiler antenna 1b according to the third embodiment. Incidentally, the external appearance of the spoiler antenna 1b is similar to that in the first embodiment shown in FIG. 1. Therefore, description about the external appearance of the spoiler antenna 1b will be omitted.

The spoiler antenna 1b according to the present embodiment is an example in which two conductive plates are arranged to overlap with each other with a predetermined gap so as to provide a capacitive coupling portion 13b in place of the capacitive coupling portion 13 which is provided by two conducting wires arranged to overlap with each other according to the first embodiment.

The spoiler antenna 1b shown in FIG. 6 includes a rear spoiler 100, an FM/DAB antenna 10b, and an AM antenna 20. Incidentally, in FIG. 6, constituents the same as those in FIG. 1 and FIG. 5 are referenced correspondingly, and description thereof will be omitted.

The FM/DAB antenna 10b is an antenna that can receive radio waves both in an FM band and in a DAB band in spite of a single antenna. The FM/DAB antenna 10b includes an antenna element 11, a passive element 12a, a capacitive coupling portion 13b, and a feeding point 14.

In the antenna element 11 according to the present embodiment, one end thereof on the side not connected to the feeding point 14 is connected a conductive plate PL2.

In addition, a conductive plate PL1 is connected to one end of the passive element 12a according to the present embodiment. The passive element 12a is capacitively coupled with the antenna element 11 through the capacitive coupling portion 13b by a predetermined capacitance value.

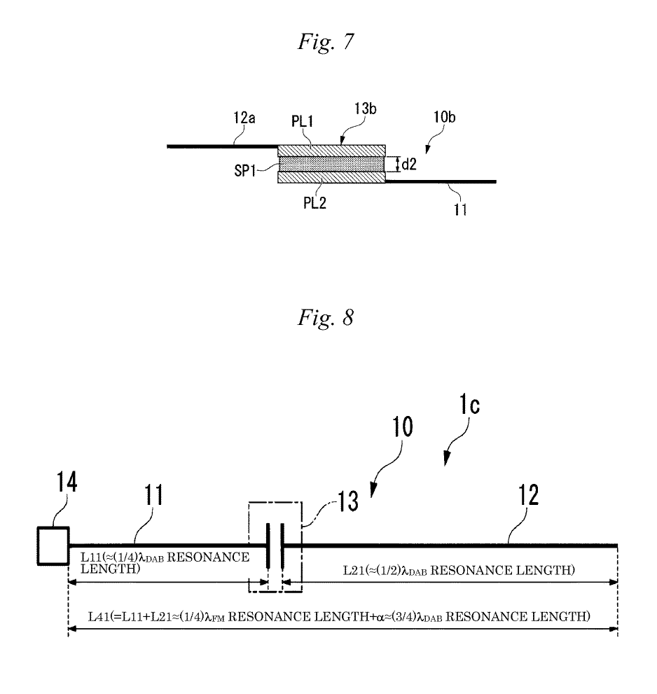

In the capacitive coupling portion 13b, the two conductive plates (PL1 and PL2) opposed to each other are arranged at a predetermined distance so that the antenna element 11 and the passive element 12a can be capacitively coupled with each other by a predetermined capacitance value. That is, the conductive plate PL1 and the conductive plate PL2 are arranged to be opposed to each other, or preferably to face to each other, while putting a predetermined distance therebetween, so as to reach a predetermined capacitance value therebetween, as shown in FIG. 7. In addition, the predetermined capacitance value is, for example, determined not to allow any signal in the FM band to pass from the antenna element 11 to the passive element 12a, in the same manner as in the first embodiment.

FIG. 7 is a sectional view showing an example of the configuration of the FM/DAB antenna 10b according to the present embodiment.

In the FM/DAB antenna 10b shown in FIG. 7, the capacitive coupling portion 13b includes a spacer SP1 arranged between the conductive plate PL1 and the conductive plate PL2.

The conductive plates (PL1 and PL2) are, for example, flat plates of conductors made of metal or the like. In addition, the spacer SP1 is a flat plate of an insulator (dielectric substance) having a thickness d2.

The conductive plate PL1 and the conductive plate PL2 are arranged to be opposed to each other, or preferably to face to each other, at the distance d2, so as to reach the predetermined capacitance value.

In addition, an equivalent circuit of the FM/DAB antenna 10b in the present embodiment is similar to that in the first embodiment shown in FIG. 3, and description thereof will be omitted. In addition, the operation of the FM/DAB antenna 10b in the present embodiment is fundamentally similar to that of the FM/DAB antenna 10 in the first embodiment, except that the antenna element 11 and the passive element 12a are capacitively coupled with each other by the capacitive coupling portion 13b in place of the capacitive coupling portion 13.

As described above, according to the spoiler antenna 1b according to the present embodiment, the feeding point 14 is connected to one end of the antenna element 11, and the conductive plate PL2 (first conductive plate) which is a conductor is connected to the other end thereof. On the other hand, the conductive plate PL1 (second conductive plate) which is a conductor is connected to one end of the passive plate 12a. The conductive plate PL1 and the conductive plate PL2 are arranged to be opposed to each other at a predetermined distance (distance d2) so as to reach a predetermined capacitance value therebetween.

Thus, according to the spoiler antenna 1b according to the present embodiment, an antenna capable of receiving in a plurality of frequency bands can be miniaturized, and the antenna can be mounted in a limited space within the rear spoiler 100, in the same manner as in the first and second embodiments.

### Fourth Embodiment

Next, a spoiler antenna 1c according to a fourth embodiment will be described with reference to the drawings.

In the fourth embodiment, description will be made about a modification in which the lengths of the antenna element 11 and the passive element 12 in the first embodiment are changed. That is, in the fourth embodiment, description will be made about a modification in which the antenna element 11 is made to serve alone as an antenna of (¼)λ_{DAB} resonance length while the antenna element 11 and the passive element 12 are made to serve as an antenna of (¼)λ_{FM} resonance length.

The configuration of the spoiler antenna 1c according to the present embodiment is fundamentally similar to that in the first embodiment shown in FIG. 1 and FIG. 2. The spoiler antenna 1c in the present embodiment is different from that in the first embodiment as to the lengths of the antenna element 11 and the passive element 12. The different point will be described with reference to an equivalent circuit shown 15 in FIG. 8. In the present embodiment, a DAB band corresponds to the first frequency band, and an FM band corresponds to the second frequency band. In addition, the present embodiment shows an example in which the first frequency band (for example, the DAB band) is higher than the second frequency band (for example, the FM band).

FIG. 8 is a diagram showing an equivalent circuit of the FM/DAB antenna 10 according to the present embodiment.

In the FM/DAB antenna 10 shown in FIG. 8, for example, the antenna element 11 has a length L11 (first length) capable of resonating with the DAB band (an example of the first frequency band). In addition, the length L11 is set to be one-quarter of a wavelength (λ) at a central frequency of the DAB band, that is, a length of (¼) wavelength (λ) ((¼)λ_{DAB} resonance length). That is, the antenna element 11 is an antenna having the length L11 almost as long as the (¼)λ_{DAB} resonance length (i.e., L11≈(¼)λ_{DAB} resonance length). The antenna element 11 can receive radio waves in the DAB band efficiently. That is, when the FM/DAB antenna 10 receives radio waves in the DAB band, the antenna element 11 serves as a (¼) wavelength antenna for the DAB band.

In addition, the length L11 may be one-quarter of a wavelength (first wavelength) within a predetermined wavelength range (first range) corresponding to the DAB band. Here, the predetermined wavelength range is a range from a wavelength obtained by multiplying a wavelength λ_{DABmin} corresponding to the highest frequency of the DAB band by a predetermined coefficient to a wavelength obtained by multiplying a wavelength λ_{DABmax} corresponding to the lowest frequency of the DAB band by a predetermined coefficient. For example, the predetermined wavelength range is expressed by (1−k)×λ_{DABmin}≦λ_{DAB}≦(1+k)×λ_{DABmax}. When k=0.21, 0.79×λ_{DABmin}≦λ_{DAB}≦1.21×λ_{DABmax}. That is, the length L11 may be (0.79×λ_{DABmin}/4) or more and (1.21×λ_{DABmax}/4) or less.

On the other hand, the passive element 12 has a length L21 (second length) capable of resonating with the FM band (an example of the second frequency band) by combining the length L21 with the length L11 of the antenna element 11. In addition, the length L21 is a length of (½)λ_{DAB} resonance length, which is longer than the length L11 (first length), causing no influence on the resonance of the antenna element 11 in the DAB band. Thus, a total length L41 of the length L21 of the passive element 12 and the length L11 of the antenna element 11 is set to be three-quarter of the wavelength (λ) at the central frequency of the DAB band (i.e., (¼)λ_{DAB} resonance length+(½)λ_{DAB} resonance length). In addition, the total length L41 of the length L11 and the length L21 is set to be (+α) longer than one-quarter of a wavelength (λ) at a central frequency of the FM band, that is, a length of (¼)λ, for example, in order to make the passive element 12 and the antenna element 11 serve as a capacitance loading type antenna.

In addition, the capacitance value by which the passive element 12 and the antenna element 11 is capacitively coupled with each other is set at a predetermined capacitance value so that the passive element 12 and the antenna element 11 can serve as a capacitance loading type antenna. That is, the total length L41 of the length L21 of the passive element 12 and the length L11 of the antenna element 11 (L41=L11+L21−(¼)λ_{FM} resonance length+α≈(¾)λ_{DAB} resonance length) is set to be (¼)λ_{FM} resonance length or more in order to make the passive element 12 and the antenna element 11 serve as a capacitance loading type antenna. Thus, radio waves in the FM band can be received efficiently. That is, in the FM/DAB antenna 10, the antenna element 11 and the passive element 12 serve as a (¼) wavelength antenna for the FM band when radio waves in the FM band are received. The length L41 of the FM/DAB antenna 10 is, for example, about 1.2 m long.

In addition, the total length L41 of the length L11 and the length L21 may be one-quarter or more of a wavelength (second wavelength) within a predetermined wavelength range (second range) corresponding to the FM band. Here, the predetermined wavelength range is a range from a wavelength obtained by multiplying a wavelength λ_{FMmin} corresponding to the highest frequency of the FM band by a predetermined coefficient to a wavelength obtained by multiplying a wavelength λ_{FMmax} corresponding to the lowest frequency of the FM band by a predetermined coefficient. For example, the predetermined wavelength range is expressed by (1−k)×λ_{FMmin}≦λ_{FM}≦(1+k)×λ_{FMmax}. When k=0.21, 0.79×λ_{FMmin}≦λ_{FM}≦1.21×λ_{FMmax}.

In this manner, the FM/DAB antenna 10 according to the present embodiment can receive radio waves in the DAB band efficiently using the antenna element 11 almost as long as the (¼)λ_{DAB} resonance length, and receive radio waves in the FM band efficiently using the antenna element 11 and the passive element 12 almost as long as the (¼)λ_{FM} resonance length, serving as a capacitance loading type antenna. That is, due to the passive element 12 added to the pointed end of the antenna element 11, the FM/DAB antenna 10 can receive both the radio waves in the FM band and the radio waves in the DAB band efficiently.

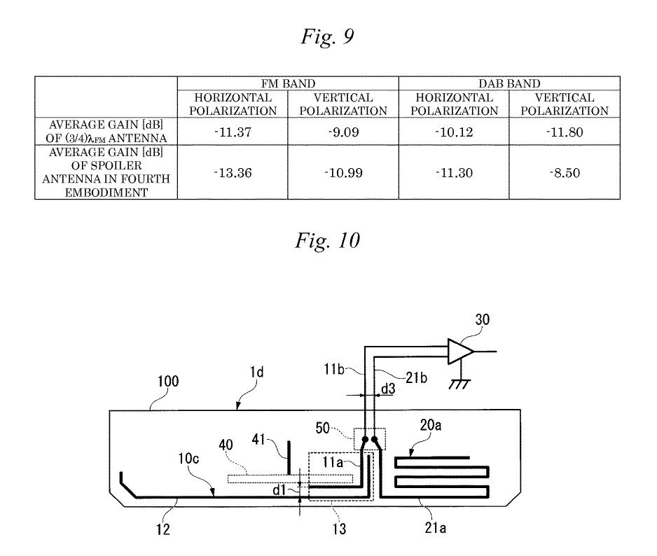

Next, the antenna characteristics of the FM/DAB antenna 10 according to the present embodiment will be described with reference to FIG. 9.

FIG. 9 is a table showing the antenna characteristics of the spoiler antenna 1c according to the present embodiment. FIG. 9 shows measurement results of antenna characteristics between a background-art antenna for the FM band and the DAB band, and the spoiler antenna 1c according to the present embodiment.

In FIG. 9, items on the vertical axis show “average gain [dB] of (¾)λ_{FM} antenna”, and “average gain [dB] of spoiler antenna according to fourth embodiment” respectively in the order from top to bottom.

On the other hand, items on the horizontal axis show “horizontal polarization” and “vertical polarization” in the “FM band” and “horizontal polarization” and “vertical polarization” in the “DAB band” respectively in the same manner as in FIG. 4.

As shown in FIG. 9, the “average gain [dB] of spoiler antenna according to fourth embodiment” is “−13.36” in “horizontal polarization” and “−10.99” in “vertical polarization” for the “FM band”. In addition, the “average gain [dB] of spoiler antenna according to fourth embodiment” is “−11.30” in “horizontal polarization” and “−8.50” in “vertical polarization” for the “DAB band”.

As a result, the measurement results shown in FIG. 9 show that the FM/DAB antenna 10 according to the present embodiment has equivalent reception characteristics for both the frequency bands of the “FM band” and the “DAB band” to those of the background-art antenna for the FM band and the DAB band. In addition, the FM/DAB antenna 10 according to the present embodiment is about 1.2 m long. The FM/DAB antenna 10 according to the present embodiment can attain miniaturization as compared with the background-art antenna for the FM band and the DAB band, which must be about 2.2 m long.

As described above, the spoiler antenna 1c according to the present embodiment includes the rear spoiler 100 to be attached to the vehicle body 2, the antenna element 11, and the passive element 12. The antenna element 11 is provided in the rear spoiler 100, and has the length L11 (first length) capable of resonating with a first frequency band (for example, the DAB band). The passive element 12 is provided in the rear spoiler 100, and capacitively coupled with the antenna element 11 by a predetermined capacitance value. The passive element 12 has the length L21 (second length) capable of resonating with a second frequency band (for example, the FM band) which is different from the first frequency band (for example, the DAB band) by combining the length L21 with the length L11 of the antenna element 11.

In this manner, the spoiler antenna 1c according to the present embodiment can receive both the first frequency band (for example, the DAB band) and the second frequency band (for example, the FM band) and can miniaturize the antenna (FM/DAB antenna 10), as shown in FIG. 9. Thus, according to the spoiler antenna 1c according to the present embodiment, an antenna capable of receiving in a plurality of frequency bands can be miniaturized, and the antenna can be mounted in a limited space within the rear spoiler 100.

In addition, according to the present embodiment, the first frequency band (for example, the DAB band) is higher than the second frequency band (for example, the FM band). The length L11 is as long as a (¼) wavelength at a frequency belonging to the first frequency band (for example, the DAB band). In addition, the total length of the length L11 and the length L21 is a length of a (¼) wavelength or more at a 10 frequency belonging to the second frequency band (for example, the FM band). For example, the length L11 is one-quarter of a wavelength at a central frequency of the first frequency band, and the total length L41 of the length L11 and the length L21 is one-quarter or more of a wavelength at a central frequency of the second frequency band. In addition, for example, the length L11 may be one-quarter of a wavelength (first wavelength: λ_{DAB}) within a first range (for example, 0.79×λ_{DABmin}≦λ_{DAB}≦1.21×λ_{DABmax}) corresponding to the first frequency band. On the other hand, the total length L41 of the length L11 and the length L21 may be one-quarter or more of a wavelength (second wavelength: λ_{FM}) within a second range (for example, 0.79×λ_{FMmin}≦λ_{FM}≦1.21×λ_{FMmax}) corresponding to the second frequency band.

In this manner, according to the spoiler antenna 1c according to the present embodiment, reception both in the first frequency band (for example, the DAB band) and in the second frequency band (for example, the FM band) can be attained, while the antenna (FM/DAB antenna 10) can be miniaturized to be about +a longer than the (¼) wavelength of the second frequency band (for example, the FM band).

In addition, according to the present embodiment, the length L21 is one-half of the wavelength at the central frequency of the first frequency band (for example, the DAB band). In addition, for example, the length L21 may be one-half of the first wavelength (λ_{DAB}). In addition, for example, the length L21 may be one-half of a third wavelength (λ_{DAB}′) within the first range. The third wavelength (λ_{DAB}′) may be a length that is as long as the first wavelength (λ_{DAB}), or may be a length that is different from the first wavelength (λ_{DAB}).

Thus, according to the spoiler antenna 1c according to the present embodiment, the influence of the passive element 12 on the resonance of the antenna element 11 in the DAB band can be reduced.

### Fifth Embodiment

Next, a spoiler antenna 1d according to a fifth embodiment will be described with reference to the drawings.

The fifth embodiment is a modification of the fourth embodiment. The fifth embodiment shows an example in which the length L1 of the antenna element 11 is set as a length including connection wiring to the amplifier 30.

FIG. 10 is a diagram showing an internal configuration example of the spoiler antenna 1d according to the present embodiment. Incidentally, the external appearance of the spoiler antenna 1d is similar to that in the first embodiment shown in FIG. 1, and description thereof will be omitted.

The spoiler antenna 1d shown in FIG. 10 includes a rear spoiler 100, an FM/DAB antenna 10c, an AM antenna 20a, and a connection connector 50. Incidentally, in FIG. 10, constituents the same as those in FIG. 1 and FIG. 2 are referenced correspondingly, and description thereof will be omitted.

The FM/DAB antenna 10c is an antenna that can receive radio waves in both an FM band and a DAB band in spite of a single antenna. The FM/DAB antenna 10c includes an antenna element 11a, a connection wiring 11b, a passive element 12, and a capacitive coupling portion 13.

The antenna element 11a is made of a conducting wire, which is, for example, a metal wire covered with an insulator (dielectric) coating. The antenna element 11a is set so that the total length of the antenna element 11a and the connection wiring 11b which is connected to the amplifier 30a and connected to the antenna element 11a through the connection connector 50 is a length L11 (first length) capable of resonating with a DAB band (an example of a first frequency band). For example, the total length L11 of the length of the antenna element 11a and the length of the connection wiring 11b is set to correspond to (¼)λ_{DAB} resonance length.

On the other hand, the passive element 12 has a length L21 (second length) capable of resonating with the FM band (an example of the second frequency band) by combining the length L21 with the length L11 of the antenna element 11a and the connection wiring 11b. In addition, the total length L41 of the length L11 and the length L21 is, for example, set to be (+α) longer than one-quarter of a wavelength λ_{FM} at a central frequency of the FM band, that is, (¼)λ_{FM} resonance length, in order to make the passive element 12 and the antenna element 11a serve as a capacitance loading type antenna.

In addition, regarding the antenna element 11a and the passive element 12, their conducting wires (interconnections) are arranged while putting a distance d1 (predetermined distance) therebetween and being overlapped with each other by a length L31 (predetermined length) so as to reach a predetermined capacitance value therebetween. The length L31 and the distance d1 are set so as to obtain a capacitance value with which the antenna element 11a and the passive element 12 can serve as a capacitance loading type antenna. The distance d1 is, for example, a value of 30 mm or less.

The AM antenna 20a is an antenna that can receive radio waves for AM radio. The AM antenna 20a includes an antenna element 21a, and a connection wiring 21b which is connected to the amplifier 30a and connected to the antenna element 21a through the connection connector 50.

The connection wiring 11b and the connection wiring 21b are arranged so that their conducting wires (interconnections) can overlap with each other at a distance d3 (predetermined distance). The distance d3 is set as a distance with which the FM/DAB antenna 10c and the AM antenna 20a can be capacitively coupled with each other. The distance d3 is, for example, a value of 30 mm or less.

The antenna element 21a is made of a conducting wire, which is a metal wire covered with an insulator coating. For example, the antenna element 21a has a meandering pattern of the conducting wire. In addition, a total length L42 of the length of the antenna element 21a and the length of the connection wiring 21b is set as a length capable of receiving radio waves for AM radio, and in consideration of influence on the characteristics of the FM/DAB antenna 10c. The length L42 is, for example, set as a length capable of resonating with the DAB band.

The amplifier 30 according to the present embodiment is connected to the antenna element 11a through the connection wiring 11b, and also connected to the antenna element 21a through the connection wiring 21b. In addition, in the present embodiment, a feeding point to the FM/DAB antenna 10c and the AM antenna 20a may be placed in the connection connector 50 or in an input terminal (not shown) of the amplifier 30.

The connection connector 50 connects the antenna element 11a and the connection wiring 11b with each other, and electrically connects the antenna element 21a and the connection wiring 21b with each other.

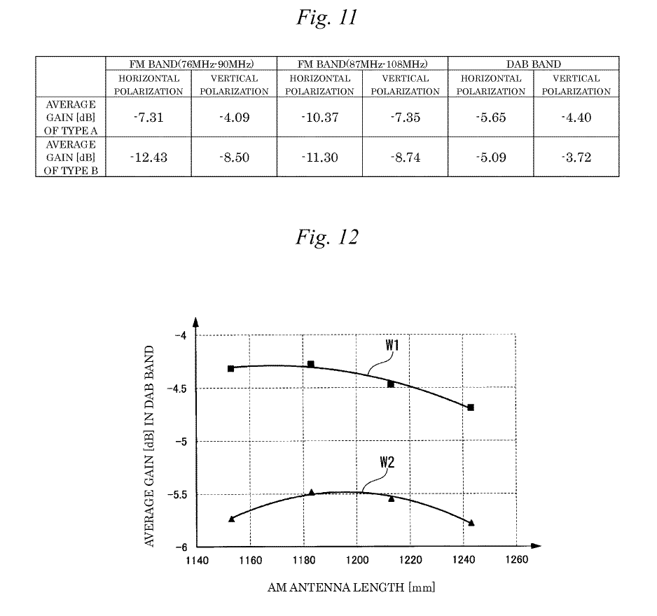

Next, the antenna characteristics of the FM/DAB antenna 10c according to the present embodiment will be described with reference to FIG. 11.

FIG. 11 is a table showing the antenna characteristics of the spoiler antenna 1d according to the present embodiment. FIG. 11 shows measurement results of antenna characteristics between two examples (“Type A” and “Type B”) which are different from each other in length of FM/DAB antenna 10c and length of the AM antenna 20a.

In FIG. 11, items on the vertical axis show “average gain [dB] of Type A”, and “average gain [dB] of Type B” respectively in the order from top to bottom.

On the other hand, items on the horizontal axis show “horizontal polarization” and “vertical polarization” in the “FM band (76 MHz to 90 MHz)”, “horizontal polarization” and “vertical polarization” in the “FM band (87 MHz to 108 MHz)”, and “horizontal polarization” and “vertical polarization” in the “DAB band”, respectively.

In addition, in “Type A”, the antenna element 11a is 240 mm long, the connection wiring 11b is 90 mm long, and the total length L11 of the antenna element 11a and the connection wiring 11b is 330 mm. In addition, the passive element 12 is 860 mm long, the length L31 of the capacitive coupling portion 13 is 220 mm, and the L21 obtained by subtracting the length L31 of the capacitive coupling portion 13 from the length of the passive element 12 is 640 mm. In addition, the total length L41 of the length L11 and the length L21 is 970 mm. In addition, the antenna element 21a is 1,065 mm long, the connection wiring 21b is 93 mm long, and the total length L42 of the antenna element 21a and the connection wiring 21b is 1.158 mm.

In the case of “Type A”, the resonance frequency using the length L11 as (¼)λ is 227 MHz within the DAB band, and the resonance frequency using the length L41 as (¼)λ is 77.3 MHz within the FM band. In addition, the resonance frequency using the length L41 as (¾)λ is 194 MHz within the DAB band.

On the other hand, in “Type B”, the antenna element 11a is 260 mm long, the connection wiring 11b is 90 mm long, and the total length L11 of the antenna element 11a and the connection wiring 11b is 350 mm. In addition, the passive element 12 is 870 mm long, the length L31 of the capacitive coupling portion 13 is 240 mm, and the L21 obtained by subtracting the length L31 of the capacitive coupling portion 13 from the length of the passive element 12 is 630 mm. In addition, the total length L41 of the length L11 and the length L21 is 980 mm. In addition, the antenna element 21a is 1,100 mm long, the connection wiring 21b is 93 mm long, and the total length L42 of the antenna element 21a and the connection wiring 21b is 1,193 mm.

In the case of “Type B”, the resonance frequency using the length L11 as (¼)λ is 214 MHz within the DAB band, and the resonance frequency using the length L41 as (¼)λ is 76.5 MHz within the FM band. In addition, the resonance frequency using the length L41 as (¾)λ is 189 MHz within the DAB band.

As shown in FIG. 11, the “average gain [dB] of Type A” is “−7.31” in “horizontal polarization” and “−4.09” in “vertical polarization” for the “FM band (76 MHz to 90 MHz)”. In addition, the “average gain [dB] of Type A” is “−10.37” in “horizontal polarization” and “−7.35” in “vertical polarization” for the “FM band (87 MHz to 108 MHz)”. In addition, the “average gain [dB] of Type A” is “−5.65” in “horizontal polarization” and “−4.40” in “vertical polarization” for the “DAB band”.

On the other hand, the “average gain [dB] of Type B” is “−12.43” in “horizontal polarization” and “−8.50” in “vertical polarization” for the “FM band (76 MHz to 90 MHz)”. In addition, the “average gain [dB] of Type B” is “−11.30” in “horizontal polarization” and “−8.74” in “vertical polarization” for the “FM band (87 MHz to 108 MHz)”. In addition, the “average gain [dB] of Type B” is “−5.09” in “horizontal polarization” and “−3.72” in “vertical polarization” for the “DAB band”.

As shown in FIG. 11, in each case of “Type A” and “Type B”, the FM/DAB antenna 10c according to the present embodiment has reception characteristics equal to or higher than the FM/DAB antenna 10 according to the fourth embodiment shown in FIG. 9, as to both the frequency bands of “FM band” and “DAB band”.

In this manner, according to the present embodiment, the length of the connection wiring 11b connecting the antenna element 11a with the amplifier 30 is included in the length L11 and the length L41. Thus, the reception characteristics of the FM/DAB antenna 10c can be further improved.

Next, the relationship between the AM antenna length and the antenna characteristics of the FM/DAB antenna 10c will be described with reference to FIG. 12.

FIG. 12 is a graph showing an example of the relationship between the AM antenna length and the antenna characteristic in the DAB band according to the present embodiment.

In the graph shown in FIG. 12, the ordinate designates the average gain [dB] in the DAB band in the FM/DAB antenna 10c in the case of “Type A”, and the abscissa designates the antenna length (length L42) of the AM antenna 20a. In addition, in the graph, a characteristic waveform W1 designates the characteristic waveform of “vertical polarization” in the “DAB band”, and a characteristic waveform W2 designates the characteristic waveform of “horizontal polarization” in the “DAB band”.

According to the present embodiment, the connection wiring 21b of the AM antenna 20a and the connection wiring 11b of the FM/DAB antenna 10c are arranged so that their conducting wires (interconnections) can overlap with each other at the distance d3, thereby being capacitively coupled with each other. Accordingly when the antenna length (length L42) of the AM antenna 20a is changed, the reception characteristics of the FM/DAB antenna 10c in the DAB band change as shown by the characteristic waveform W1 and the characteristic waveform W2 in FIG. 12. Therefore, according to the present embodiment, the reception characteristics of the FM/DAB antenna 10c can be improved by adjusting the antenna length (length L42) of the AM antenna 20a.

As described above, according to the spoiler antenna 1d according to the present embodiment, the length of the connection wiring 11b connecting the antenna element 11a with the amplifier 30 is included in the length L11 and the length 41 in the FM/DAB antenna 10c. That is, the length L11 and the length L41 are set to start at the amplifier 30. In addition, the length L11 is one-quarter of a wavelength (first wavelength) within a predetermined wavelength range (first range) corresponding to the DAB band (first frequency band), and the length L41 is one-quarter or more of a wavelength (second wavelength) within a predetermined wavelength range (second range) corresponding to the FM band (second frequency band).

In this manner, in the spoiler antenna 1d according to the present embodiment, it is taken into consideration that the connection wiring 11b connecting the antenna element 11a with the amplifier 30 serves as an antenna. Thus, the reception characteristics of the FM/DAB antenna 10c can be improved more than in the fourth embodiment. In addition, according to the spoiler antenna 1d according to the present embodiment, the antenna in the rear spoiler 100 (resin-made member) can be further miniaturized.

In addition, in the present embodiment, the connection wiring 21b of the AM antenna 20a and the connection wiring 11b of the FM/DAB antenna 10c are arranged so that their conducting wires (interconnections) can be arranged to overlap with each other at a predetermined distance (distance d3), thereby being capacitively coupled with each other.

In this manner, according to the spoiler antenna 1d according to the present embodiment, the AM antenna 20a and the FM/DAB antenna 10c can be capacitively coupled with each other. Thus, the reception characteristics of the FM/DAB antenna 10c can be further improved.

Incidentally, the present invention is not limited to the aforementioned embodiments, but may be changed without departing from the gist of the present invention.

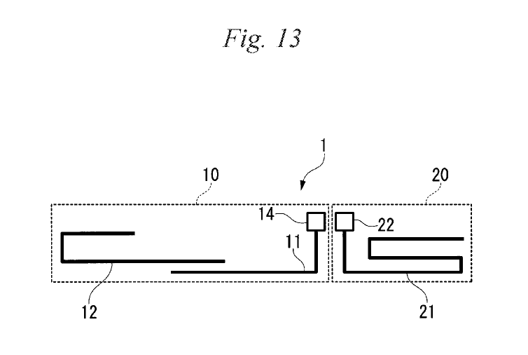

For example, although each embodiment shows an example in which the passive element 12 (12a) is arranged straightly, the passive element 12 (12a) may be arranged to be bent within the rear spoiler 100 as shown in FIG. 13.

FIG. 13 is a diagram showing a modification of the FM/DAB antenna 10 according to the first embodiment.

The FM/DAB antenna 10 may be designed to have a passive element 12 whose conducting wire is bent as shown in FIG. 13. In this manner, the FM/DAB antenna 10 can be mounted in a limited space within the rear spoiler 100 even in a car that is short in width of the vehicle body 2.

In addition, although each embodiment shows an example in which the spoiler antenna 1 (1a to 1d) has the AM antenna 20 (20a) in addition to the FM/DAB antenna 10 (10a to 10c), the spoiler antenna 1 (1a to 1d) does not have to include the AM antenna 20 (20a) but may have only the FM/DAB antenna 10 (10a to 10c). In addition, the FM/DAB antenna 10 (10a to 10c) in each embodiment may be also used as an AM antenna. That is, the FM/DAB antenna 10 (10a to 10c) may be used as an AM antenna and an FM/DAB antenna.

In addition, although each embodiment shows an example in which the spoiler antenna 1 (1a to 1d) has the FM/DAB antenna 10 (10a to 10c) used for receiving radio waves in both the FM band and the DAB band, the spoiler antenna 1 (1a to 1d) may be used for receiving radio waves in other frequency bands.

In addition, although each embodiment shows an example in which the FM/DAB antenna 10 (10a to 10c) receives two kinds of frequency bands, the present invention is not limited thereto. For example, the FM/DAB antenna 10 (10a to 10c) may have two or more passive elements and connect them by capacitive coupling in order to receive radio waves in higher frequency bands.

In addition, although each embodiment shows an example in which the wavelength of the FM band is regarded as a wavelength at the central frequency of the FM band, the present invention is not limited thereto. For example, a wavelength at another frequency may be used as long as it is a wavelength at a frequency belonging to the FM band.

In addition, although each embodiment shows an example in which the wavelength of the DAB band is regarded as a wavelength at the central frequency of the DAB band, the present invention is not limited thereto. For example, a wavelength at another frequency may be used as long as it is a wavelength at a frequency belonging to the DAB band.

In addition, although the passive element 12 (12a) is provided on the vehicle body 2 side in the capacitive coupling portion 13 (13b) in each embodiment, the antenna element 11 (21) may be provided on the vehicle body 2 side.

In addition, although each of the antenna element 11 (11a, 21, 21a) and the passive element 12 (12a) is made of a conductor that is a metal wire covered with an insulator (dielectric) coating in each embodiment, it may have a configuration in which a conducting wire is arranged on a dielectric substrate. Further, any variation is allowed as to the length of each element as long as the variation does not impair the effect of the present invention.

In addition, although each embodiment shows an example in which the resin-made member is a rear spoiler 100, the rear spoiler 100 may be replaced by another resin-made member such as a tail gate or a trunk as long as it is a resin-made member which can be attached to the vehicle body.

In addition, although each embodiment shows an example in which k=0.21 is used as an example of the coefficient k for use in the predetermined wavelength ranges, another value may be used. In addition, the coefficient k for use in the upper limit value of each predetermined wavelength range may be different from the coefficient k for use in the lower limit value thereof.

The present application is based on Japanese Patent Application No. 2015-174733 filed on Sep. 4, 2015, Japanese Patent Application No. 2016-124671 filed on Jun. 23, 2016, and Japanese Patent Application No. 2016-156710 filed on Aug. 9, 2016, the contents of which are incorporated herein by reference.

### DESCRIPTION OF REFERENCE NUMERALS AND SIGNS

1, 1a, 1b, 1c, 1d spoiler antenna
2 vehicle body
10, 10a, 10b, 10c FM/DAB antenna
11, 11a, 21, 21a antenna element
11b, 21b connection wiring
12, 12a passive element (parasitic element)
13, 13b capacitive coupling portion
13a capacitor
14, 22 feeding point
20, 20a AM antenna
30 amplifier
40 high mount strop lamp (HMSL)
41 stop lamp wiring
50 connection connector
100 rear spoiler
SL1, PL2 conductive plate
SP1 spacer

What is claimed is:

1. An antenna comprising:
a resin-made member to be attached to a vehicle body:
an antenna element which is provided in the resin-made member and has a first length capable of resonating with a first frequency band; and
a passive element which is provided in the resin-made member, capacitively coupled with the antenna element via a capacitive coupling portion, and has at least a region of a second length capable of resonating with a second frequency band which is different from the first frequency band by combining the second length with the first length of the antenna element.

2. The antenna according to claim 1, wherein the antenna element and the passive element are arranged while putting a predetermined distance therebetween and being overlapped with each other by a third length, thereby being capacitively coupled with each other; and
the passive element has a length in which the third length is added to the second length.

3. The antenna according to claim 1, wherein the antenna element and the passive element are capacitively coupled with each other through a capacitor.

4. The antenna according to claim 1, wherein a first conductive plate which is a conductor is connected to one end of the antenna element,
a second conductive plate which is a conductor is connected to one end of the passive element, and
the first conductive plate and the second conductive plate are arranged to be opposed to each other while putting a predetermined distance therebetween.

5. The antenna according to claim 1, wherein the second frequency band is higher than the first frequency band, and
the first length is one-quarter of a first wavelength within a first range corresponding to the first frequency band, and a total length of the first length and the second length is three-quarter of a second wavelength within a second range corresponding to the second frequency band.

6. The antenna according to claim 5, wherein the capacitive coupling portion has a capacitance value not to allow any signal in the first frequency band to pass therethrough.

7. The antenna according to claim 1, wherein the first frequency band is higher than the second frequency band, and
the first length is one-quarter of a first wavelength within a first range corresponding to the first frequency band, and a total length of the first length and the second length is one-quarter or more of a second wavelength within a second range corresponding to the second frequency band.

8. The antenna according to claim 7, wherein the second length is one-half of a third wavelength within the first range.

9. The antenna according to claim 1, wherein the antenna element and the passive element are arranged so as not to cross any interconnection arranged in the resin-made member.

10. The antenna according to claim 1, wherein the resin-made member is a rear spoiler.
